(19) United States
(12) Patent Application Publication
(10) Pub. No.: US 2014/0370259 A1
(43) Pub. Date: Dec. 18, 2014

(54) THIN COATINGS ON MATERIALS

(71) Applicant: NANO-NOUVELLE PTY LTD, Marcoola, Queensland (AU)

(72) Inventors: Geoffrey Allan Edwards, Arkwright (AU); Quansheng Song, Maroochydore (AU); Peter Anthony George, Marcoola (AU)

(21) Appl. No.: 14/375,931

(22) PCT Filed: Feb. 1, 2013
(86) PCT No.: PCT/AU2013/000088

§ 371 Date: Jul. 31, 2014

(30) Foreign Application Priority Data
Feb. 2, 2012 (AU) 2012900378
Dec. 21, 2012 (AU) 2012905644

(51) Int. Cl. C23C 18/38; C23C 18/31; C23C 18/32; B05D 7/00

(52) U.S. Cl. CPC C23C 18/38; B05D 7/5483; C23C 18/31; C23C 18/32
USPC 428/216; 428/319.1; 427/404

(57) ABSTRACT

A method for depositing a metal containing material onto a porous substrate, the method comprises forming a seed coating on the substrate, wherein the seed coating at least partially covers the substrate, the seed coating being substantially free of precious metal and applying a metal containing material to the seed coating, wherein the surface area of the substrate is greater than 0.02 m²/cc, as determined prior to coating the substrate. Non-porous substrates may also be coated using a similar process.

### FIELD OF THE INVENTION

The present invention relates to the application of thin coatings to materials.

### BACKGROUND TO THE INVENTION

Thin surface coatings are desirable for many applications including, electronics, optics, photovoltaic cells, catalysis, packaging, protective coatings and many others. Thin coatings have the advantages of modifying the surface properties of a material, for example to impart conductivity, to catalyse a surface reaction, to change the optical properties, etc. The use of a thin surface coating of material to impart desirable properties, as opposed to a ‘thick’ film, has the advantage of reducing material use, thus reducing cost and minimising weight and volume. Additionally, the thin coating may avoid significantly altering desirable bulk material properties such as flexibility, strength, shape, porosity, or others.

Surface coatings can be deposited using various methods including solution based methods such as chemical bath deposition, successive ionic layer adsorption and reaction, electroless and electro deposition, and others, or by gas phase deposition methods, such as sputtering, physical vapour deposition, chemical vapour deposition, atomic layer deposition, and others. Gas phase deposition methods have the disadvantage that they often require expensive equipment and chemicals. Additionally, for many deposition methods it is often difficult to obtain thin, uniform and dense surface coatings, particularly for substrates with complex geometries, such as porous membranes.

In order to enable the deposition of a surface coating substrates often have to be first modified by processes such as etching, plasma treatment, adsorption of a molecule, or others. Sometimes the application of a first surface coating is undertaken which allows subsequent surface coating/s to occur. In this way it may be possible to coat surfaces with vastly different chemistries with the same material. However, these processes are often non-uniform, costly, require aggressive conditions, and do not uniformly modify the surfaces of substrates with complex geometries, such as porous membranes.

Surface coatings are also used extensively as seed layers enabling further deposition or modification of the material to which they are applied. The seed layer can be comprised of a wide variety of materials including metals, metal oxides, and many others.

Examples of metallic seed layers include palladium, platinum, copper, nickel, gold, etc. These layers can enable various further surface modification/deposition, e.g. subsequent electroless deposition, the formation of self-assembled monolayers (gold in particular), or the specific adsorption of biomolecules (nickel in particular).

Electroless plating of substrates is a well-known process that is widely used in a number of industrial applications. By electroless plating, we mean deposition from solution, whereby the deposition does not proceed through use of an applied voltage and current to electroplate the solid. Electroless plating can be used to deposit a wide variety of materials including metals (copper, nickel, gold and others) and metal oxides (iron oxide, cobalt oxide, and others). Electroless plating has several advantageous properties including being cost-effective, solution based and capable of large scale continuous operation.

Electroless plating is widely applied in the electronics industry for the fabrication of electronic interconnect devices (ICs), through hole plated printed circuit boards (PCBs), flat panel displays, and many others. Electroless plating is also used industrially for coating materials to improve their wear resistance, hardness, corrosion properties, aesthetic appeal, etc.

In order for electroless plating to occur onto a material the surface of that material must be active to the electroless deposition solution. The normal commercial electroless plating process therefore involves the activation of the material surface (often referred to as seeding or sensitisation).

Several methods of seeding electroless metal deposition have been developed, the most common approach being palladium seeding. In this method a palladium metal is dispersed onto the surface of the material to be coated. This dispersion of palladium onto the surface of the material is usually achieved via one of two common methods:
1. Adsorption of a tin species onto the surface from highly acidic tin ion containing solutions, followed by introduction of a palladium ion containing solution. The adsorbed tin ions reduce the palladium ions to palladium metal resulting in a dispersion of palladium metal clusters on the surface.
2. Tin-palladium colloids are adsorbed to the surface. The tin is removed by dissolution in a highly acidic solution leaving a dispersion of palladium metal clusters on the surface.

There are variations on these methods.

U.S. Pat. No. 3,011,920 to Shipley et al, U.S. Pat. No. 6,180,523 B1 to Lee et al, U.S. Pat. No. 6,362,090 to Paik et al, and EPI 196016 to Itabashi are referenced as indicative prior art practice.

Alternative seeding methods have been developed for electroless metal plating, including the physical deposition of metal layers (e.g. by sputtering), metal ion adsorption and reduction (sometimes to surface modified substrates, e.g. with self-assembled monolayers), adsorption of colloids of hydrous metal oxides followed by their reduction to metal particles, etc. However, these methods have not been adopted commercially due to inherent problems with their application. U.S. Pat. No. 6,225,221 to Ho et al., U.S. Pat. Nos. 4,136,216, 4,131,699 and U.S. Pat. No. 5,009,965 to Feldstein provide examples of alternative seeding methods for electroless deposition.

Other methods for electroless plating also exist, for example methods for silver deposition, sometimes referred to as ‘silver mirroring’. In these methods, metal ion, is reduced by a reducing agent in solution and then deposits on the substrate.

Existing methods for depositing thin films, including those that are designed to seed further deposition, such as for electroless deposition, have several limitations including:
it is difficult to produce thin, uniform layers,
they cannot deposit a wide range of materials,
they are difficult to implement at large scale,
they contain harsh processing steps, e.g. tin ion solutions typically have pH <1,
they are not suitable for use with some difficult substrates (e.g. polymeric substrates may not withstand the processing conditions),
they have a high cost (e.g. palladium metal used for seeding electroless deposition),
the deposit does not adhere well to the substrate,
they do not uniformly coat three-dimensional structures such as trenches, holes, channels, tortuous pore structures, or porous membranes,
the density of catalytic sites/active sites provided by the films for subsequent reaction/adsorption/deposition is low (e.g. metal ion adsorption and reduction for electroless plating).

The density of catalytic sites provided by a seed layer for electroless deposition has a determining factor on the minimum thickness of the electroless coating required to produce a continuous film. As the electroless deposition is initiated and grows outwards from the nucleating sites a high density of nucleation facilitates thin continuous films, whereas a low density of catalytic sites will require a greater film thickness to achieve a continuous film.

It would be desirable to develop a method for the deposition of thin films that overcomes at least some of the limitations of existing methods.

It is an object of the present invention to provide new methods and materials for depositing thin, uniform coatings of metal-containing compounds on substrates.

It is another object of some embodiments of the present invention to provide new methods and materials for depositing thin, uniform coatings of metal-containing compounds on substrates, that is suited to three dimensional substrates including porous substrates and porous substrates with complex, tortuous pore structures.

It is another object of some embodiments of the present invention to provide new methods and materials for electroless deposition of thin, uniform coatings of metal-containing compounds on substrates, that avoid the use of a precious metal-containing seed layer.

### BRIEF DESCRIPTION OF THE INVENTION

In a first aspect, the present invention provides a method for depositing a metal containing material onto a porous substrate, the method comprising:
(a) forming a seed coating on the substrate, wherein the seed coating at least partially covers the substrate, the seed coating being substantially free of precious metal; and
(b) applying a metal containing material to the seed coating, wherein the surface area of the substrate is greater than 0.02 m²/cc, as determined prior to coating the substrate.

Throughout this specification, “precious metals” will be considered to comprise gold, silver and the platinum group metals (platinum, palladium, rhodium, ruthenium, iridium and osmium). A “non-precious Metal” is a metal that is not one of the precious metals.

Throughout this specification, the term “substantially free of precious metals” is to be understood to mean that precious metals, if present, are present only at impurity levels or in trace amounts. In this aspect, the present invention does not require the deliberate addition of precious metals.

The method for forming the seed coating may comprise:
(i) applying a chemically reducible metal containing material to the substrate, and
(ii) subsequently chemically reducing at least part of the chemically reducible metal containing material to form a seed coating.

In some embodiments, the metal containing material applied in step (b) forms a layer having a thickness of less than 500 nm, or less than 300 nm, or less than 200 nm, or less than 100 nm, or less than 50 nm, or less than 30 nm. The metal containing material may form an electrically conductive layer.

In some embodiments, the substrate has a surface area of at least 0.05 m²/cm³, or at least 6.07 m²/cm³, or at least 0.1 m²/cm³, or at least 0.2 m²/cm³, or at least 0.5 m²/cm³, or at least 1.0 m²/cm³, or from 0.02 to 4 m²/cm³, or from 0.02 to 10 m²/cm³.

In some embodiments, the porous substrate is first coated with a surface modification material. comprising a metal and oxygen, wherein the surface modification material at least partially coats the porous substrate. The coating of surface modification material may be less than 5nm thick, preferably less than 2nm thick, even more preferably less than 1 nm thick. The surface modification material may be applied using atomic layer deposition.

The step of chemically reducing the chemically reducible metal containing material may comprise chemically reducing the chemically reducible metal containing material to reduce at least some of the chemically reducible metal containing material to a metal.

The chemically reducible metal containing material may comprise a hydroxide, an oxyhydroxide or a carbonate, or mixtures of two or more thereof.

Other chemically reducible metal containing materials may be used in the coating applied in step (b). Other chemically reducible metal compounds. that may be used include metal carbonates and metal oxyhydroxides. Any other. chemically reducible metal containing materials that can form a layer on the surface of the substrate and subsequently be reduced may also be used in the present invention.

The chemically reducible metal containing material may comprise a nickel containing material, or a copper containing material, or a nickel containing material and a copper containing material.

In some embodiments, the substrate may have a volume fraction of pores of at least 30%, as determined prior to coating the substrate. The substrate may have a volume fraction of pores of at least 50%.

The porous substrate may comprise a tortuous and/or a complex pore structure.

In some embodiments, at least part of the porosity in the substrate is interconnected and open to the surface.

The metal containing material applied in step (b) may increase electrical conductivity.

The substrate may comprise an insulating substrate.

The substrate may comprises a porous substrate and a maximum particle size of a particle that can pass through the porous substrate is less than 20 μm, or less than 10 μm.

The substrate may comprise a porous polymeric material. The substrate may comprise a porous polymeric material selected from cellulose, cellulose acetate, cellulose nitrate, a mixed cellulose ester, nylon, polytetrafluoroethylene (PTFE), polyether sulfone (PES), a polyamide, a vinyl polymer, polypropylene, polyurethane, polyethylene, polyvinylidene fluoride PVDF or a polycarbonate. The substrate may comprise a filter membrane. The filter membrane may comprise a cellulose based filter membrane. The filter membrane may comprise a polyethersulfone-based filter membrane

In some embodiments, the substrate may have a thickness of at least 1 μm. The substrate may have a thickness of at least 100 μm, preferably in the range of from 100 μm to 500 μm.

In some embodiments, deposition of any of the coatings is carried out from fluid that flows through at least some of the pores in the membrane.

In some embodiments, the equivalent conductivity of the material after the metal containing material is applied greater than 1×10³ S/m, or greater than 1×10⁴ S/m, or greater than 1×10⁵ S/m, or greater than 1×10⁶ S/m, or between 1×10³ S/m to 1×10⁷S/m.

In some embodiments, the metal-containing material is applied to the substrate from a liquid that is flowed through the membrane.

The first coating and the second coating may comprise different materials to each other. The first coating may comprise a layer of material or a plurality of layers of material. The second coating may comprise a layer of further material or a plurality of layers of further material.

The metal-containing material that is applied in step (b) of the third aspect of the present invention may comprise a metal containing compound. The metal containing compound may be a copper compound or a nickel compound. The metal containing compound may be copper hydroxide or nickel hydroxide. It may also be a mixture of compounds. Various elements may additionally be incorporated in the layer. For example, the second coating may be deposited from a solution of metal salts. The metal salts have counter ions, eg. chlorides, nitrates, sulphates, carbonates and the like. The counter ions may be incorporated into the second coating. They may be incorporated as compounds, for example there may be mixtures of metal hydroxides and metal salts present in the thin layer.

The metal containing material may also be comprised of nanosized particles of the materials listed above.

In some embodiments, the seed coating applied in step (a) may comprise a compound containing at least a metal and oxygen.

In some embodiments, the metal containing material is applied as a thin layer of material.

In a second aspect, the present invention provides a method for depositing a metal containing material onto a substrate, the method comprising:
a) applying a coating comprising metal and oxygen to the substrate, wherein the average thickness of this coating is less than 5 nm, preferably less than 2 nm, even more preferably less than 1 nm,
b) forming a seed coating on the coating in (a), the seed coating being substantially free of precious metal; and
c) applying the metal containing material to the seed layer.

In some embodiments, the coating applied in step (b) is essential for electroless deposition. In some embodiments, the coating applied in step (b) is reduced prior to applying the metal containing material.

Throughout this specification, “precious metals” will be considered to comprise gold, silver and the platinum group metals (platinum, palladium, rhodium, ruthenium, iridium and osmium). A “non-precious metal” is a metal that is not one of the precious metals.

Throughout this specification, the term “substantially free of precious metals” is to be understood to mean that precious metals, if present, are present only at impurity levels or in trace amounts. In this aspect, the present invention does not require the deliberate addition of precious metals.

The steps of forming the seed layer and applying the metal containing material to the seed layer in the second aspect of the present invention may comprise similar steps to those described with reference to the first aspect of the present invention.

In some embodiments of the first and second aspects of the present invention, the metal containing material is applied by electroless coating.

In a third aspect the present invention provides a method for deposition of thin coatings onto a surface, comprising the steps of:
d) modifying the surface by applying a thin layer of material that includes at least a metal and oxygen and that enables deposition of a layer of further material, and
e) applying the layer of further material to the surface resulting from step (a) above, the layer of further material comprising a metal-containing compound,
   wherein the thin layer of material applied in step (a) facilitates coating of the layer of further material.

The method may further comprise the step of reducing the layer formed in step (b). The step of reducing the layer formed in step (b) may reduce the metal-containing compound to a metal.

In a fourth aspect, the present invention provides a method for electroless deposition of thin coatings onto a surface, comprising the steps of:
a) modifying the surface by applying a thin layer of a material that includes at least a metal and oxygen and that enables deposition of a layer of further material,
b) applying the layer of further material to the surface resulting from step (a) above, the layer of further material comprising a metal-containing compound,
c) optionally reducing the layer formed in step (b) and,
d) applying a coating via an electroless solution,
   wherein the layer of further material applied in step (b) facilitates the electroless deposition.

In some embodiments, the coating applied in step (b) and reduced in step (c) of the fourth aspect of the present invention is essential for the electroless deposition.

In all aspects of the present invention, the substrate to be coated may be any substrate that is, by itself, unsuitable for the application of the desired material composition with the desired coating process. For example, in some embodiments, the substrate cannot, by itself, catalyse the deposition of a desired material via a desired electroless plating recipe.

The substrate may be an inorganic substrate or an organic substrate. The substrate may be a composite material containing both inorganic and organic material. Organic substrates may include carbon and polymers or mixtures of polymers. Inorganic substrates include ceramic materials such as metal oxides, metal nitrides, metal carbides, etc. They can also include metals. This list is not considered exhaustive.

The substrate may be flat or ‘three-dimensional’ (3D). By 3D it is meant that the substrate contains features that renders the substrate non-flat. 3D-substrates include trench structures, etched surfaces, surfaces with nanotubes or nanowires, porous materials, porous membrane materials, porous materials with complex pores, and porous materials with tortuous porosity, meshes and foams and the like. This list is not considered exhaustive. By porous materials with complex pore structures, it is meant that the porosity may vary considerably both in size and shape, and may follow non-straight or tortuous paths. Such structures can be very difficult to apply thin uniform coatings due to restricted flow and diffusion of species through the structure.

3D structures are inherently more difficult to coat with thin, uniform coatings as geometrical restrictions to flow and increased path lengths can limit delivery of reactive species to the surface.

The 3D substrate may have significantly increased surface area relative to a flat surface. For example, the surface area may be greater than 0.02 m²/cm³, or greater than 0.1 m²/cm³, or greater than 1 m²/cm³, or greater than 10 m²/cm³, or greater than 100 m²/cm³ or greater than 500 m²/cm³.

In one embodiment of the present invention, the substrate may be a polymeric membrane. Polymeric membranes include filter membranes. These may be made from a variety of polymers, including cellulose, cellulose nitrate, cellulose acetate, mixed cellulose esters, nylon, PTFE (Teflon®), polyether sulfones (PES), polyamides, vinyl polymers and polycarbonates. The membranes are available in a range of pore types and sizes. Typically the pore sizes are specified by the maximum particle size that can pass through the membrane. For example, a particular membrane type may be available in specified pore sizes from 0.1 μm to 10 μm. Track-etched filter membranes (typically polycarbonates) have straight cylindrical pores. However many membranes have much more complex and irregular pore structures. These include the cellulose-based filter membranes, and some nylon, PTFE and PES filter membranes. Companies that manufacture such filter membranes include Pall Corporation, GE Whatman, Advantec, and Sterlitech.

The filter membrane may have significantly increased surface area relative to a flat surface. For example, the surface area may be greater than 0.02 m²/cm³, or greater than 0.1 m²/cm³, or greater than 1 m²/cm³, or greater than 4 m²/cm³, or greater than 10 m²/cm³.

In some embodiments, the porous substrate is preferably about 200 micrometres thick, approximately 75% porosity, and a surface area of at least 5 m²/cm³, preferably 10 m²/cm².

The surface area is determined by the Brunauer. Emmett and Teller (BET) method. This method is known by those skilled in the art.

The first thin coating that is applied in step (a) of the fourth aspect of the present invention may be of any material that enables deposition of the second thin coating. In one embodiment the first thin coating, on its own, enables deposition of the subsequent coating or layer of further material by itself. In other embodiments, there may be some interaction between the coating and the substrate that enables deposition of the subsequent coating. In other embodiments, the first thin coating may be further treated to enable or improve deposition of the subsequent coating of further material.

In some embodiments, the first thin coating comprises a metal oxide such as aluminium oxide, zinc oxide, titanium oxide; tin oxide, copper oxide, iron oxide, nickel oxide, cobalt oxide, etc.

In some embodiments, the first coating comprises a surface modification material comprising a metal and oxygen, wherein the surface modification material at least partially coats the porous substrate.

The first thin coating is preferably very thin. The first thin coating may be preferably less than 200 nm, or more preferably less than 100 nm, or more preferably less than 50 nm, or more preferably less than 25 nm, or more preferably less than 10nm, or more preferably less than 5nm, or more preferably less than 2 nm thick. Thinner coatings result in less weight of material, less volume of material, and can result in cost savings both in materials use and processing time. These features can be advantageous in many applications. For example in applications where the material is to be used as an electrode, and coated with an active material, and the active material requires mass flow throughout a porous network, it may be desirable to keep the volume fraction of solid as low as possible, so as to maximise porosity and hence mass flow. It may also be desirable to keep the amount of conducting material in an electrode to a minimum, so that the ratio of active material deposited on the electrode to the conducting material is maximised.

The first thin coating applied in step (a) of the fourth aspect of the present invention, or the surface modification material of the first aspect of the present invention, may be applied by any suitable method. A particularly suitable method for applying the first thin coating is atomic layer deposition (ALD). ALD is a deposition method that is known for its ability to apply conformal coatings to variable surfaces, for its accurate control of coating thickness, and for its ability to deposit very thin, pin-hole free coatings. In ALD, precursors are added to a chamber at low pressure and form a layer on the surface. This layer acts as a barrier to further precursor deposition. The precursors are purged, and then a reactant gas is added that reacts with the precursor layer to form a product that is able to accept another monolayer of precursor. Thus, areas that are more exposed to precursor gases receive exactly the same layer coating as areas that take longer to be exposed to precursors. It is known that films deposited by ALD may be ‘pinhole-free’ at much thinner thicknesses compared to other methods. ALD thereby offers control of layer deposition at an unparalleled fine scale. The coatings produced by ALD are commonly ‘conformal’, i.e. they conform to the shape of the substrate.

In other embodiments, the first thin coating applied in step (a) of the fourth aspect of the present invention, (which may be the surface modification material of the first and second aspects of the present invention) may be applied by any suitable method for depositing a thin coating. In some embodiments, the first thin coating may be applied to the surface by various means. For example, the first thin coating may be applied by atomic layer deposition, electrodeposition, electroless deposition, hydrothermal methods, electrophoresis, photocatalytic methods, sol-gel methods, other vapour phase methods such as chemical vapour deposition, physical vapour deposition and close-spaced sublimation. Multiple layers using one or more of these methods may also be used. It may be useful to coat the material such that the composition of the final material is not uniform throughout. For example, a coating method may be used that only penetrates partway into a porous material. The coating may also be applied by sequential use of different coating methods

In one embodiment, the first thin coating comprises a uniform coating that uniformly covers the exposed surfaces of the substrate material. The first thin coating may be free from defects, openings, gaps or pin holes.

The first thin coating should be applied using conditions that do not unduly result in damage to the underlying substrate. For example, conditions of excessive temperature, excessive acidity or excessive alkalinity may damage certain substrates and render them unsuitable for either subsequent depositions or final use.

The first thin coating preferably adheres well to the substrate. This is to ensure that the first thin coating, and subsequent coatings, do not easily come off the substrate during subsequent processing Or use.

The first thin coating preferably is sufficiently stable during subsequent processing operations. If the coating is not sufficiently stable, then it may be damaged during subsequent processing, and subsequent coatings may not be deposited properly.

In some embodiments, the first thin coating is applied to three dimensional substrates including porous substrates. In such embodiments, the thin coating should penetrate at least partially into the 3D substrate.

The first thin coating is used to facilitate application of the layer of further material. By this, it is meant that the first thin coating is required to allow the layer of further material to be applied to the material (and, in the absence of the first thin coating, the layer of further material could not be applied to the substrate). Effectively, the first thin coating must be present in order to allow the layer of further material to be applied to the substrate.

The layer of further material applied in step (b) of the fourth aspect of the present invention is able to be deposited on the first thin layer of material. For convenience, this layer may be referred to as “the second coating”. The second coating may act as a seed layer that facilitates subsequent or further coatings or layers.

In some embodiments, the second coating or the seed coating is preferably a thin layer. The second coating may be preferably less than 500 nm, or more preferably less than 250 nm, or more preferably less than 200 nm or more preferably less than 100 nm, or more preferably less than 50 nm, or more preferably less than 25 nm, or more preferably less than 10 nm, or more preferably less than 5 nm thick. Thinner coatings result in less weight of material, less volume of material, and can result in cost savings both in materials use and processing time. These features can be advantageous in many applications. For example in applications where the material is to be used as an electrode and coated with an active material and the active material requires mass flow throughout a porous network, it may be desirable to keep the volume fraction of solid as low as possible, so as to maximise porosity and hence mass flow.

In further embodiments the second coating acts as a seed layer for subsequent deposition of a further coating or coatings. In these embodiments, the second coating should be sufficiently active towards the subsequent deposition. The second layer may be further treated to render it more active to subsequent deposition. In some embodiments, the second coating may be heat treated prior to further treatment or further deposition. In some embodiments, the second layer is a catalytic seed layer for electroless deposition. In one aspect the second layer is reduced prior to electroless deposition. In another aspect, the second layer is heat treated, then reduced prior to electroless deposition. In further aspects, the reduced second layer is comprised of a high density of catalytic sites for subsequent electroless deposition. In one embodiment, the reduction is via chemical reduction from solution.

The second coating preferably adheres well to the first coating. This is to ensure that the second coating, and any subsequent coatings, do not easily come off the substrate during subsequent processing or use.

The second coating or seed coating preferably is sufficiently stable during subsequent processing operations. If the coating is not sufficiently stable, then it may be damaged during subsequent processing, and subsequent coatings may not be deposited properly.

In some embodiments, the second coating or seed coating is applied to thin coatings on three dimensional substrates including porous substrates. In such embodiments, the second coating should penetrate at least partially into the 3D substrate. In some embodiments, the second coating may penetrate through the entire extent of a 3D substrate. In other embodiments, the second coating only penetrates partially into the 3D substrate. In some embodiments, the second coating extends partially into a 3D substrate from one side of the substrate. In other embodiments, the second coating extends partially into the 3D substrate from both sides of the substrate.

In some embodiments, the substrate is a porous substrate in which the pores are interconnected and are at least partly connected to one or more outer surfaces of the substrate. Such interconnected porosity may be advantageous for access of chemical species via fluids.

In some embodiments, the methods used for providing the coatings may involve passing fluid through a porous substrate. On reason for doing this may be to improve diffusion of chemical species during the coating process.

Any suitable method for depositing the thin coating or seed coating may be used. The second coating or seed coating should be applied using conditions that do not unduly damage the underlying substrate. For example, conditions of excessive temperature, excessive acidity or excessive alkalinity may damage certain substrates and render them unsuitable for either subsequent depositions or final use.

The second coating applied in step (b) of the fourth aspect of the present invention or the seed coating of the first and second aspects of the present invention may be applied by any suitable method for depositing a thin coating. In some embodiments, the coating of further material may be applied to the surface by various means. For example, further layers may be applied by atomic layer deposition, electrodeposition, electroless deposition, hydrothermal methods, electrophoresis, photocatalytic methods, sol-gel methods, other vapour phase methods such as chemical vapour deposition, physical vapour deposition and close-spaced sublimation. Multiple layers using one or more of these methods may also be used. It may be useful to coat the material such that the composition of the final material is not uniform throughout. For example, a coating method may be used that only penetrates partway into a porous material. The coating may also be applied by sequential use of different coating methods.

In some embodiments, it may be desirable that the method comprises deposition of the second coating from a solution, eg. an aqueous solution. In some embodiments a thin second coating is deposited from a solution containing metal ions, in which the pH has been adjusted to promote deposition of the thin coating. In some aspects, the pH of this solution is in a ‘mild’ range, e.g. from about pH 3-11, or pH 4-10, or pH 5-9.

In some embodiments, the second coating contains a metal hydroxide. Examples of suitable metal hydroxide may include Pd hydroxide, Cu hydroxide. Ni hydroxide, or Ag hydroxide. The second coating may also contain other elements. For example, the second coating may be deposited from a solution of metal salts. The metal salts have counter ions, eg. chlorides, nitrates, sulphates, carbonates, and the like. The counter ions may be incorporated into the second coating.

Some embodiments of the method of the present invention may include the step of reducing the second coating. The step of reducing the second coating may result in partial reduction of the further material in the second coating. In other embodiments, the step of reducing the second coating may result in the further material of the second coating being reduced to a metal.

In other embodiments the layer formed in step (b) may be partially or fully reduced. This means that regions of the layer may be reduced and regions may not be reduced. In other embodiments the degree to which the layer is reduced may also vary. For example, various states of reduction from a metal hydroxide, eg. from Cu(OH)₂ to CuO, or to Cu or even to a copper hydride may occur. Various mixtures of these reduced states may also occur.

The step of reducing the second coating may comprise contacting the second coating with a reducing agent. The second coating may be contacted with a gaseous reducing agent. The second coating may be contacted with a liquid reducing agent or with a reducing agent in solution. The reducing agent in solution may be an aqueous solution or a non-aqueous solution. Any reducing agent known to be suitable to the person skilled in the art for reducing metal-containing compounds may be used.

The first coating and the second coating may comprise different materials to each other. The first coating may comprise a layer of material or a plurality of layers of material. The second coating may, comprise a layer of further material or a plurality of layers of further material.

In a fifth aspect, the present invention provides a method for deposition of thin coatings onto a porous substrate, comprising the steps of:
a) modifying the surface with a thin layer of material that enables deposition of a layer in step (b),
b) further coating the surface obtained in step (a) with a thin layer of material that is a metal-containing compound, and
c) optionally reducing the layer formed in step (b).

In a sixth aspect, the present invention provides a method for electroless deposition of thin coatings onto a porous substrate, comprising the steps of:
a) optionally coating the surface with a thin layer of material that enables deposition of the layer in step (b),
b) coating the surface with a thin layer of material that is a metal-containing material.
c) optionally reducing the layer formed in step (b), and
d) applying a coating via an electroless solution,
wherein the coating applied in step (b) is essential for electroless deposition in step (d).

In some embodiments, the coating applied in step (b) and reduced in step (c) is essential for the electroless deposition. In some embodiments, the coating applied in step (b) of the sixth aspect comprises a chemically reducible metal containing material.

In embodiments of the fourth to sixth aspects of the present invention, steps (a), (b) and (c) may be as described with reference to the second aspect of the present invention.

The thin layer that is deposited in step (a) may be deposited by atomic layer deposition.

The thin layer that is deposited in step (a) may comprise a Very thin layer, for example, less than 10 nm in thickness, or less than 5 nm in thickness, or less than 2 nm in thickness.

The thin layer that is deposited in step (a) may comprise a metal oxide layer. The metal oxide may be Al₂O₃, ZnO, TiO₂, or mixtures of two or more thereof.

The seed coating applied in step (b) may comprise a metal hydroxide. The metal hydroxide may be selected from palladium hydroxide, copper hydroxide, nickel hydroxide, or silver hydroxide. In some aspects. the metal hydroxide is a non-precious metal hydroxide, such as copper hydroxide or nickel hydroxide, and is substantially free of precious metals. It has been unexpectedly found that in some embodiments electroless deposition may take place on a metal compound that does not contain a precious metal, such as copper hydroxide or nickel hydroxide that has been reduced to some degree. As precious metals are expensive, this has apparent implications for the economy of the process, particularly where it is desired to coat large surface area materials.

Other chemically reducible metal containing materials may be used in the coating applied in step (b). Other chemically reducible metal compounds that may be used include metal carbonates and metal oxyhydroxides. Any other chemically reducible metal containing materials that can form a layer on the surface of the substrate and subsequently be reduced may also be used in the present invention.

The coating that is applied in step (b) may be applied from a solution. The solution may comprise an aqueous solution.

Where the coating of step (b) is subjected to an optional reduction step, the reduction step may comprise a chemical reduction.

In some embodiments of the present invention, the overall thickness of the thin layer and the layer of further material applied to the substrate may be less than 100 nm, preferably less than 50 nm, preferably less than 30 nm, preferably less than 20 nm, more preferably less than 10nm.

In some embodiments of the present invention, the first coating applied to the substrate results in surface modification of the substrate to enable the second coating to be applied. The second coating applied is suitably able to catalyse subsequent electroless deposition. The second coating may require further treatment prior to the electroless deposition step. For example, the second coating may be reduced prior to the electroless deposition step. The second coating may be amenable to reduction. The second coating is desirably a thin coating, for example, less than 100 nm, preferably less than 50 nm, more preferably less than 20 nm, or less than 10 nm. The second coating suitably has sufficient area density for the subsequent electroless deposition step to result in an effective coating being formed in the electroless deposition step. The second coating desirably sufficiently adheres to the first coating. The second coating will typically comprise a metal-containing compound. The second coating preferably is able to survive in an electroless solution or an electroless bath. The second coating may comprise a metal hydroxide. The metal hydroxide may optionally be reduced to a metal prior to electroless deposition. In some embodiments, some of the metal hydroxide may be reduced and some may not.

In aspects of the present invention where a subsequent coating or layer is applied by electroless deposition, the electroless coating is suitably a thin coating. The electroless coating may be less than 500 nm thick, or less than 250 nm thick, or less than 100 nm thick, or less than 50nm thick, or less than 25 nm thick. It will be understood that the thickness of the coating will somewhat depend upon the application in which the coated material is to be used. Accordingly, it will be understood that the thickness of the coating may vary from the ranges given above. The electroless coating may comprise a uniform coating. In embodiments where the substrate is a porous substrate, the electroless coating may extend through all of the thickness of the substrate, or it may extend only partially into the substrate. In parts of the substrate where the electroless coating has been applied, the electroless coating may be substantially uniform. In these aspects where the subsequent coating is applied by electroless deposition, those skilled in the art will recognise that metals deposited using electroless methods are often alloys or compounds, or mixtures of alloys and compounds, where the alloying or compounding element is provided by the reducing agent used. For example, nickel deposited using sodium borohydride or dimethylamine borane reducing agents may contain boron, whilst nickel deposited using sodium hypophosphite may contain phosphorus.

In one embodiment of the present invention, thin, uniform coatings are deposited that can be used as seed layers for subsequent deposition of a further thin, uniform coating or coatings.

In another embodiment, the substrates can be substrates that are difficult to coat.

In another embodiment, the thin, uniform coatings can be used as seed layers for subsequent electroless deposition of a further thin, uniform coating.

In other embodiments, a further coating or coatings is applied to the second coating. In some aspects, these further coatings are thin and uniform. In further aspects, these further coatings are applied to three dimensional substrates, including porous substrates. In such embodiments, the subsequent coatings should penetrate at least partially into the 3D substrate.

In one aspect the further coating or coatings are applied via electroless deposition from solution. Examples of metals that may be deposited using electroless deposition include copper, nickel and tin. Alloys with more than one metal may also be deposited. Compounds such as metal phosphorous and metal boron based materials are also possible.

Electroless deposition ideally occurs via a surface reaction where a reducing agent in solution reduces metal ions via interaction with a catalytic site on the surface. The reducing agent is oxidised and the metal ions in solution are reduced, resulting in metal on the surface. Examples of such catalysts in solution include amine boranes, formaldehydes, hydrazine, borohydrides, hypophosphites, ascorbic acid, etc.

In another aspect the electroless coating exhibits good conductivity. In yet another aspect, the electroless coating is thin and exhibits good conductivity.

In other embodiments, the second coating acts as a seed layer for subsequent deposition of a coating, but does not contain significant amounts of precious metals. In one aspect, the second coating is first chemically reduced, which enables the second coating to provide a sufficiently high density of catalytic sites to enable subsequent electroless deposition of thin, uniform coatings.

In other embodiments the second coating can act as a seed layer for subsequent deposition of materials other than thin coatings, for example nanotubes, nanowires and the like.

The inventors have surprisingly discovered that, in accordance with some embodiments of the present invention, the application of certain thin, uniform films to substrates can cause subsequent deposition of thin, uniform metal-containing films that would otherwise not occur on the substrate. The inventors have further discovered that the thin films may be extremely thin, and can promote further deposition of thin, metal-containing coatings from solution. The inventors have also discovered that such structures can act as suitable seed layers for subsequent deposition of further coatings.

The inventors have also surprisingly discovered that these methods may be applied to achieve thin, uniform coatings that at least partially penetrate into three-dimensional structures including complex porous polymer structures. Such coatings may be described using an ‘average coating thickness’. The average coating thickness is defined as the volume of coating per unit of total volume, divided by the surface area of substrate. The volume of coating per unit of total volume may be estimated by measuring the weight increase due to coating in a specific volume, then dividing by the density of the coating to get the volume of the coating, then dividing by the total volume.

The inventors have also surprisingly discovered that thin, uniform coatings that at least partially penetrate into three-dimensional structures including complex porous polymer structures may be achieved that have good conductivity, even with thin coatings. In some aspects, these coatings with good conductivity comprise a metal or metal alloy, or mixtures of metals or metal alloys, or mixtures of metals and metal alloys. The conductivity of such coated structures may be defined by an ‘equivalent conductivity’. The equivalent conductivity of a porous material is hereby defined as the measured conductivity divided by the volume fraction of solid. In other words, the measurement of conductivity is corrected for the fact that not all the volume is a conductor in a porous material. For example, if the conductivity of a porous solid is measured as ‘x’, however the volume fraction of solid conducting material is 0.2 or 20%, then the equivalent conductivity is 5×.

In some embodiments of the present invention, the porous substrate may be at least partially comprised of fibres. In some embodiments, the fibres may be polymeric. The fibrous substrate may also be a complex structure, by which we mean that the structure may be comprised of fibres of varying diameter and/or length, the fibres may follow tortuous or complex paths, and the porous space defined by the fibres may be irregular in terms of both size and shape.

In a seventh aspect, the present invention provides a material comprising a substrate having a first thin layer applied to a surface thereof, and a layer of further material applied to the first layer, the layer of further material comprising a metal-containing compound. Preferably, the first thin layer of material application of the layer of further material.

In an eighth aspect, the present invention provides a material comprising a substrate having a thin layer of a material that includes at least a metal and oxygen and that enables deposition of a layer of further material, a layer of further material applied to the thin layer, the layer of further material comprising a metal-containing compound, and a further layer applied to the layer of further material. Preferably, the further layer is applied by electroless deposition. In some embodiments, the thin layer is reduced prior to applying the layer of further material. The thin layer may comprise a layer of a metal.

In a ninth aspect, the present invention provides a material comprising a substrate having a thin layer of material applied thereto, and a layer of further material applied to the thin layer, the layer of further material comprising a metal-containing compound, where the metal is a non-precious metal, and the coating is deposited from solution. Preferably, the thin layer is essential for application of the layer of further material.

The present invention also extends to material made using one or more of the methods of the present invention.

In a tenth aspect, the present invention provides a material comprising a porous substrate with a thin, uniform coating that coats at least part of the porous substrate, and which is comprised of at least a seed layer and a metal layer, wherein the seed layer is substantially free of precious metals and is deposited from solution, and the metal layer is deposited by electroless deposition.

In an eleventh aspect, the present invention provides a material comprising a complex porous substrate with a thin, uniform coating that penetrates significantly into the porous substrate, and which is comprised of at least a seed layer and a metal layer, wherein the seed layer is substantially free of precious metals and the metal layer is deposited by electroless deposition.

In a twelfth aspect, the present invention provides a material comprising a polymer substrate with a thin, uniform coating of a compound containing metal and oxygen. with a further thin, uniform coating of a metal containing material that contains substantially no precious metal and can act as a seed layer for electroless deposition, where the further thin uniform coating of a metal containing material is deposited from solution.

The seed layer may contain no precious metal. Alternatively, the seed layer may comprise trace amounts of precious metal or an amount of precious metal that is sufficiently small so as to not materially alter the properties of the seed layer.

The further thin coating may contain no precious metal. Alternatively, the further thin layer may comprise trace amounts of precious metal or an amount of precious metal that is sufficiently small so as to not materially alter the properties of the further thin layer.

In a further aspect, the present invention provides a coated material comprising:
a porous substrate, and
a coating that at least partially coats the porous substrate, the coating comprising
   a seed coating substantially free of precious metal, and
   a metal containing material on the seed coating, wherein the surface area of the porous substrate is at least 0.02 m²/cm².

The metal containing material on the seed layer may have a thickness of less than 500 nm, or less than 250 nm, or less than 200 nm, or less than 100 nm, or less than 50 nm, or less than 25 nm, or less than 10 nm, or less than 5 nm thick. The equivalent conductivity of the material is greater than greater than 1×10³ S/m, or greater than 1×10⁴ S/m, or greater than 1×10⁵ S/m, or greater than 1×10⁶ or between 1×10³ S/m to 1×10⁷ S/m.

The substrate may have a thickness of at least 1 μm. The substrate may have a thickness of at least 100 μm preferably in the range of from 100 μm to 500 μm.

The seed coating may have a thickness of less than 20 nm, preferably less than 10nm, more preferably less than 5 nm.

At least some of the pores in the substrate may be interconnected.

In some embodiments, the metal containing material comprises a layer of metal containing material on the seed layer.

In some embodiments, the coated material may further comprise a surface modification coating of a metal and oxygen applied to the substrate, the seed layer being applied to the layer of the metal and oxygen. A thickness of the surface modification coating may be less than 5 nm, preferably less than 2 nm, even more preferably less than 1 nm.

In some embodiments, the seed layer comprises a nickel containing material, or a copper containing material, or a nickel containing material and a copper containing material. The seed layer may comprise nickel, or copper, or nickel and copper.

In some embodiments, the metal containing material increases electrical conductivity of the material.

In some embodiments, the substrate has a volume fraction of pores of at least 20%, preferably greater than 30%, even more preferably greater than 50%, as determined prior to coating of the substrate. In some embodiments, the substrate comprises a tortuous and/or a complex pore structure.

In some embodiments, the substrate comprises an insulating substrate.

In some embodiments, the substrate has a surface area of at least 0.05 m²/cm³, or at least 0.07 m²/cm³, or at least 0.1 m²/cm³, or at least 0.2 m²/cm³, or at least 0.5 m²/cm³, or at least 1.0 m²/cm³, or from 0.02 to 4 m²/cm³, or from 0.02 to 10 m²/cm³.

In some embodiments, the substrate comprises a porous substrate and a maximum particle size of a particle that can pass through the porous substrate is less than 10 μm, or less than 5.1 m, or less than 3 μm, or less than 2 μm, or less than 1 nm, or less than 0.5 μm, or less than 0.1 μm.

In some embodiments, the substrate comprises a porous polymeric material. The substrate may comprise a porous polymeric material selected from cellulose, cellulose acetate, cellulose nitrate, a mixed cellulose ester, nylon, polytetrafluoroethylene (PTFE), polyether sulfone (PES), a polyamide, a vinyl polymer, polypropylene, polyurethane, polyethylene, polyvinylidene fluoride PVDF or a polycarbonate. The substrate may comprise a filter membrane. The filter membrane may comprise a cellulose based filter membrane or a polyethersulfone (PES) based filter membrane.

In some embodiments, the metal containing material on the seed layer comprises a metal hydroxide or a metal oxyhydroxide.

In some embodiments, the equivalent conductivity of the material is greater than 1×10³ S/m, or greater than 1×10⁴ S/m, or greater than 1×10⁵ S/m, or greater than 1×10⁶ S/m or between 1×10³ S/m to 1×10⁷ S/m, or between 1×10³ S/m to 1×10⁶ S/m.

In some embodiments, the average thickness of the metal containing layer is less than 500 nm. The average thickness of the metal containing layer may be less than 100 nm or less than 50 nm, or less than 30 nm, or less than 20 nm.

In some embodiments, the surface area of the porous substrate is greater than 0.02 m²/cc, or greater than 2 m²/cc, or greater than 10 m²/cc.

In some embodiments, the coating penetrates at least 5 micrometres into the porous substrate from one or more surfaces of the substrate. In some embodiments, the coating penetrates at least 10 micrometres into the porous substrate from one or more surfaces of the substrate. In some embodiments, the coating penetrates at least 30 micrometres into the porous substrate from one or more surfaces of the substrate. In some embodiments, the coating penetrates at least 80 micrometres into the porous substrate from one or more surfaces of the substrate. In some embodiments, the coating penetrates at least 150 micrometres into the porous substrate from one or more surfaces of the substrate

In some embodiments, at least some of the pores remain interconnected after forming the metal coating. In some embodiments, the surface area after the metal coating is at least 0.02 m²/cc.

### BRIEF DESCRIPTION OF THE DRAWINGS

FIG. 1 is a schematic diagram showing some embodiments of the present invention;

FIG. 2 is a photomicrograph of SEM images showing the morphology of the cross-section from the cellulose nitrate membrane sample coated with doped ZnO from example 1;

FIG. 3 is a graph of EDS data showing Al (k) and Zn (k) integrated peak count across the cross section of the film from example 1;

FIG. 4 is a photomicrograph of SEM image showing the cross section of the membrane sample coated with 30 cycles of ZnO from example 3. The numbers mark the location of EDS analyses performed. The EDS results are listed in Table 1;

FIG. 5 is a photomicrograph of SEM image showing the morphology of the cellulose acetate membrane sample coated with 500 cycles of TiO₂ from example 4;

FIG. 6 is a photomicrograph of SEM image showing the cross section of the membrane sample coated with 500 cycles of TiO₂ from example 4. The numbers mark the location of EDS analyses performed. The EDS results are listed in Table 2;

FIG. 7 is a high resolution SEM image showing the cross section of the Al₂O₃ membrane sample coated with copper-containing compound from example 5. The texture of the copper containing compound coating can be seen in FIG. 7;

FIG. 8 is an SEM image showing the cross section of the Al₂O₃ membrane sample coated with copper containing compound from example 5. The numbers mark the location of EDS analyses performed. The EDS results are listed in Table 3;

FIG. 9 is a high resolution SEM image showing the cross section of the Al₂O₃ membrane sample coated with nickel containing compound from example 8. The texture of the nickel containing compound coating Can be seen in FIG. 9;

FIG. 10 is an SEM image showing the cross section of the Al₂O₃ membrane sample coated with nickel containing compound from example 8. The numbers mark the location of EDS analyses performed. The EDS results are listed in Table 4;

FIG. 11 is a high resolution SEM image showing the cross section of the copper coated membrane sample from example 16. The coating is thin, continuous and uniform;

FIG. 12 is an SEM image showing the cross section of the copper coated membrane sample from example 16. The numbers mark the location of EDS analyses performed. The EDS results are listed in Table 5;

FIG. 13 is an SEM image showing the cross section of the copper coated membrane sample from example 20. The numbers mark the location of EDS analyses performed; The EDS results are listed in Table 6:

FIG. 14 is a high resolution SEM image showing the cross section of the copper containing compound coated membrane sample further coated with electroless copper from example 21. The fine grains of the copper coating can be seen uniformly covering the porous membrane structure; and

FIG. 15 is an SEM image showing the cross section of the copper coated membrane sample from example 21. The numbers mark the location of EDS analyses performed. The EDS results are listed in Table 7.

### DETAILED DESCRIPTION OF THE DRAWINGS AND EXAMPLES

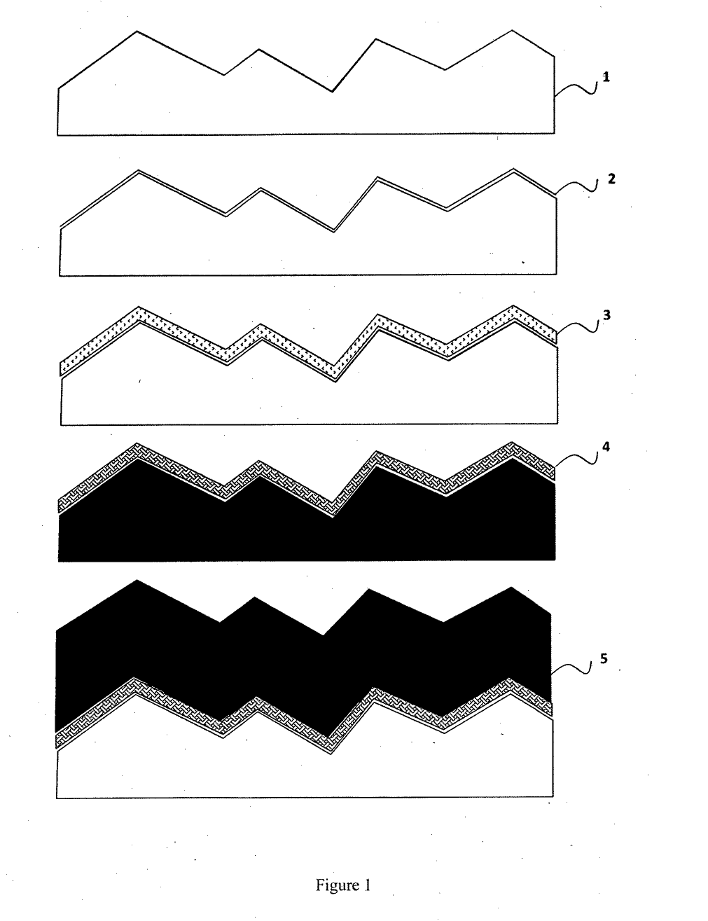

FIG. 1 contains schematic diagrams that illustrate some embodiments of the present invention. A 3-D substrate 1 is first coated with a thin coating of material 2. This coating enables deposition of the second thin coating of material 3. This second thin coating is reduced to a reduced state 4, after which it acts as a seed layer for subsequent electroless deposition of a thin, uniform coating of metal 5. The respective steps are sequentially shown in the respective diagrams of FIG. 1.

### EXAMPLES

### Example 1

### Thin Aluminium Doped ZnO Coating on Cellulose Nitrate Membrane by Atomic Layer Deposition

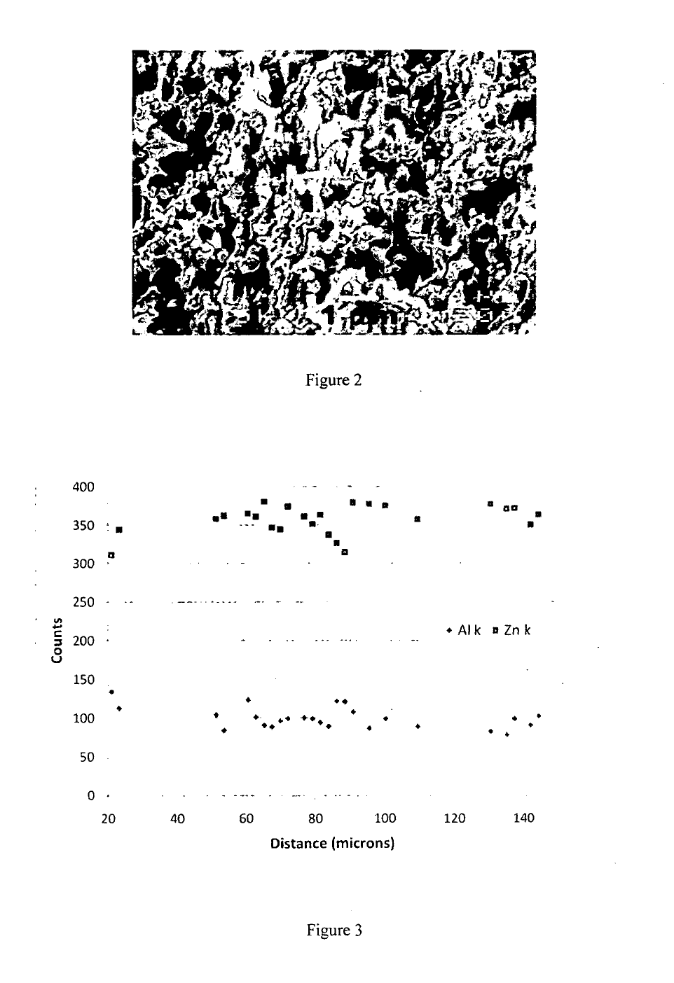

Cellulose nitrate filter membrane material with a thickness of ˜130 μm and a pore size of 0.2 μm was coated with Al₂O₃— doped ZnO using flow-through atomic layer deposition (ALD). Trimethylaluminium (TMA), Diethylzinc (DEZ) and water were used as precursors for the deposition. The substrate was exposed to 5 cycles of TMA and water to form a nucleation layer, followed by cycles of: DEZ and water, and TMA and water, to achieve a coating thickness of 12 nm. The deposition temperature was 160° C. High resolution SEM (FIG. 2) showed that the doped ZnO coating was thin, uniform and conformal to the membrane surface, with the original membrane structure being preserved. EDS results (FIG. 3) showed that the thin, uniform and conformal doped ZnO coatings were formed all through the 3D porous structure of the membranes.

### Example 2

### Thin Al₂O₃ Coating on Cellulose Acetate Membranes by Atomic Layer Deposition

Cellulose acetate filter membrane material with a thickness of ˜130 μm and a pore size of 0.2 μm was coated with Al₂O₃ using flow-through atomic layer deposition (ALD) similarly to example 1.

SEM/EDS results showed that a thin, uniform and conformal Al₂O₃ coating was formed all through the 3D porous structure of the membranes.

### Example 3

### Thin ZnO Coating on Cellulose Acetate Membranes by Atomic Layer Deposition

Cellulose acetate filter membrane material with a thickness of ˜130 μm and a pore size of 0.2 μm was coated with ZnO using flow-through atomic layer deposition (ALD). Diethylzinc (DEZ) and water were used as the precursors for the deposition. A nucleating coating of Al₂O₃ was first put down on the membrane material (using the methods described in example 1). The deposition consisted of 30 cycles of DEZ and water exposure. The deposition temperature was 160° C.

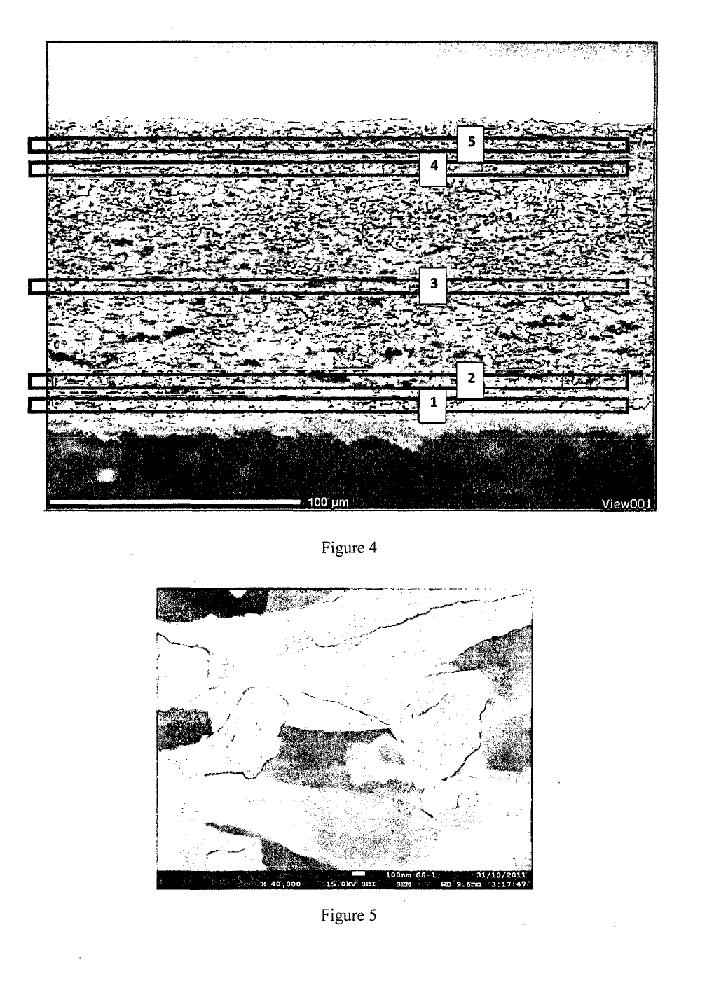

SEM/EDS results (FIG. 4) showed that thin, uniform and conformal ZnO coatings were formed all through the 3D porous structure of the membranes. The EDS results are listed in Table 1:

TABLE 1

| at % | C | O | Al | Cu | Zn | Zn/O | Zn/C |
|---|---|---|---|---|---|---|---|
| A1 | 62.05 | 36.67 | 0.01 | 0.49 | 0.78 | 0.021 | 0.013 |
| A2 | 62.44 | 36.01 | 0.02 | 0.34 | 1.19 | 0.033 | 0.019 |
| A3 | 62.76 | 34.44 | | 0.26 | 2.53 | 0.073 | 0.040 |
| A4 | 60.49 | 36.7 | 0.02 | 0.23 | 2.56 | 0.070 | 0.042 |
| A5 | 62.18 | 33.91 | 0.04 | 0.13 | 3.74 | 0.110 | 0.060 |

### Example 4

### Thin TiO₂ Coating on Cellulose Acetate Membranes by Atomic Layer Deposition

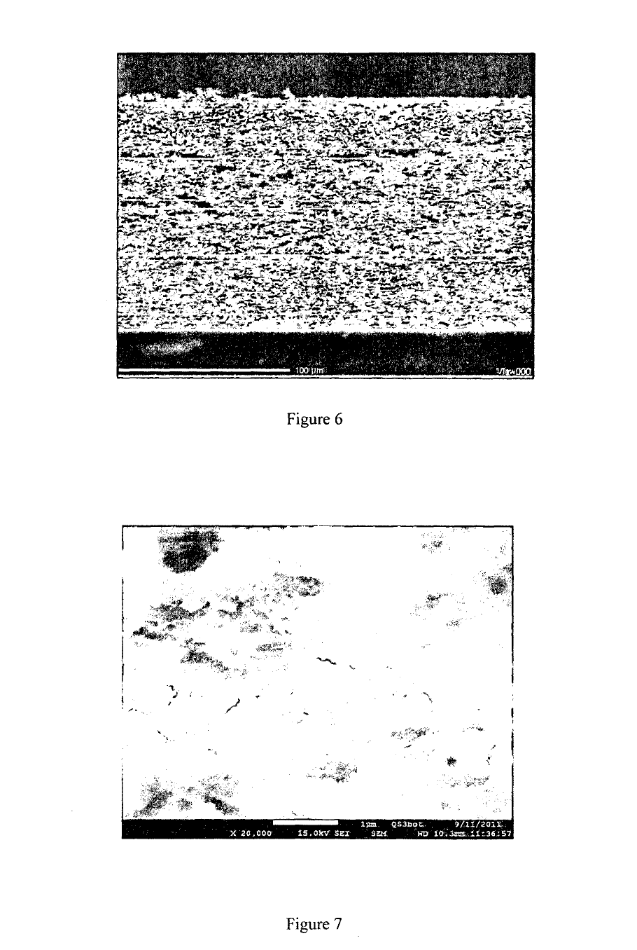

Cellulose acetate filter membrane material with a thickness of ˜130 μm and a pore size of 0.2 μm was coated with TiO₂ using flow-through atomic layer deposition (ALD). TiCl₄ and water were used as the precursors for the deposition. A nucleating coating of Al₂O₃ was first put down on the membrane material. The deposition consisted of 500 cycles of TiCl₄ and water exposure. The deposition temperature was 140° C. High resolution SEM (FIG. 5) showed that the TiO₂ coating was thin, uniform and conformal. SEM/EDS results (FIG. 6) showed that the thin, uniform and conformal TiO₂ coatings were formed all through the 3D porous structure of the membranes. The EDS results are listed in Table 2:

TABLE 2

| at | | | | | | | | Ti/ |
|---|---|---|---|---|---|---|---|---|
| % | C | O | Al | Cl | Ti | Zn | Pt | Al |
| A1 | 46.88 | 36.38 | 2.89 | 1.79 | 10.91 | 0.13 | 1.02 | 3.8 |
| A2 | 46.97 | 37.56 | 2.78 | 1.64 | 10.02 | 0.18 | 0.85 | 3.6 |
| A3 | 48.69 | 37.67 | 2.23 | 1.18 | 9.05 | 0.43 | 0.76 | 4.1 |
| A4 | 44.99 | 39.85 | 2.38 | 0.92 | 10.72 | 0.36 | 0.79 | 4.5 |
| A5 | 46.89 | 41.67 | 2.63 | 0.63 | 6.97 | 0.27 | 0.94 | 2.7 |

### Example 5

### Copper Containing Compound Coating on Al₂O₃ Coated Cellulose Acetate Membranes

A solution composition for coating copper containing compound was prepared from 0.1M CuSO₄ and 0.3M acetic acid in deionized water (pH was 5.5 adjusted with KOH solution). An Al₂O₃—coated cellulose acetate membrane was prepared similarly to example 1, and was immersed into the solution for over 4 hours at room temperature. The copper containing compound coated the membrane giving it a uniform blue colour. After the coating process, the membranes were rinsed thoroughly with deionized water and dried in oven at 60-70° C. Then the membranes coated with copper containing compound were analysed with SEM and EDS.

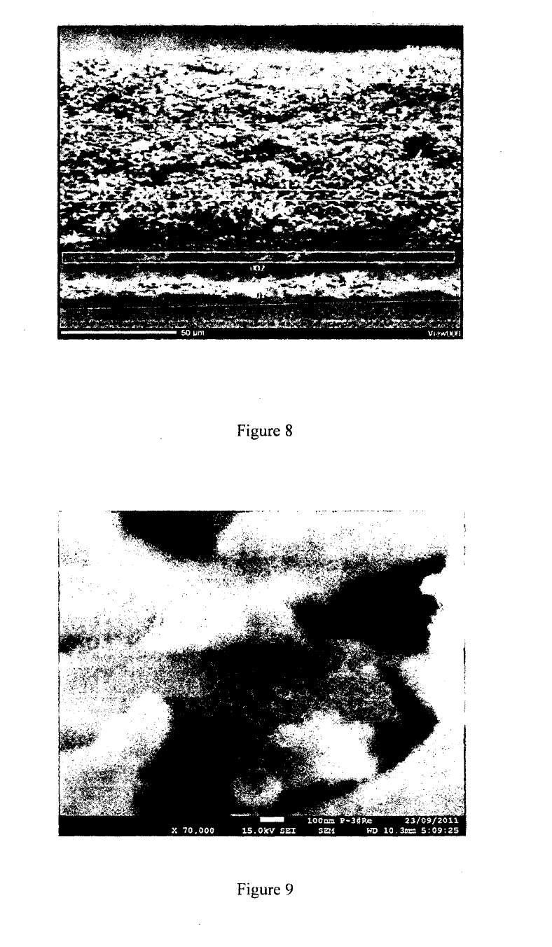

Weight measurements indicated that after coating with copper containing compound, the weight increase was 11-12% for 0.45 μm membranes and 5-6% for 0.20 μm membranes. High resolution SEM analysis (FIG. 7) and SEM/EDS analysis (FIG. 8) results indicate that a thin and uniform copper containing compound coating was formed all through the 3D porous structure of Al₂O₃ coated membranes. The EDS results are listed in. Table 3.

TABLE 3

| at % | C | O | Al | S | Cu | Zn |
|---|---|---|---|---|---|---|
| A1 | 56.21 | 37.61 | 3.26 | 1.02 | 1.89 | 0.01 |
| A2 | 57.05 | 35.19 | 3.74 | 1.47 | 2.15 | 0.41 |
| A3 | 56.98 | 36.47 | 3.37 | 1.38 | 1.8 | — |
| A4 | 56.01 | 36.51 | 3.53 | 1.55 | 2.27 | 0.13 |
| A5 | 51.94 | 38.83 | 4.31 | 1.82 | 2.93 | 0.17 |

### Example 6

### Copper Containing Compound Coating on TiO₂ Coated Cellulose Acetate Membranes

The same procedures of example 5 were followed except the cellulose acetate membranes were coated with TiO₂. The membrane sample developed a uniform blue colour and had increased in weight by 3%.

### Example 7

### Copper Containing Compound Coating on ZnO Coated Cellulose Acetate Membranes

The same procedures of example 5 were followed except the cellulose acetate membranes were coated with ZnO. The membrane sample developed a uniform blue colour and had increased in weight by ˜9%.

### Comparative Example 1

### Copper Containing Compound Coating on Cellulose Acetate Membranes without Metal Oxide Coating

The same procedures of example 5 were followed except that a cellulose acetate membrane without any coating was used. After 4 hours of immersion in the deposition solution the membrane had not changed colour and there was no weight gain, indicating that no coating had occurred.

### Example 8

### Nickel Containing Compound Coating on Al₂O₃ Coated Cellulose Acetate Membranes

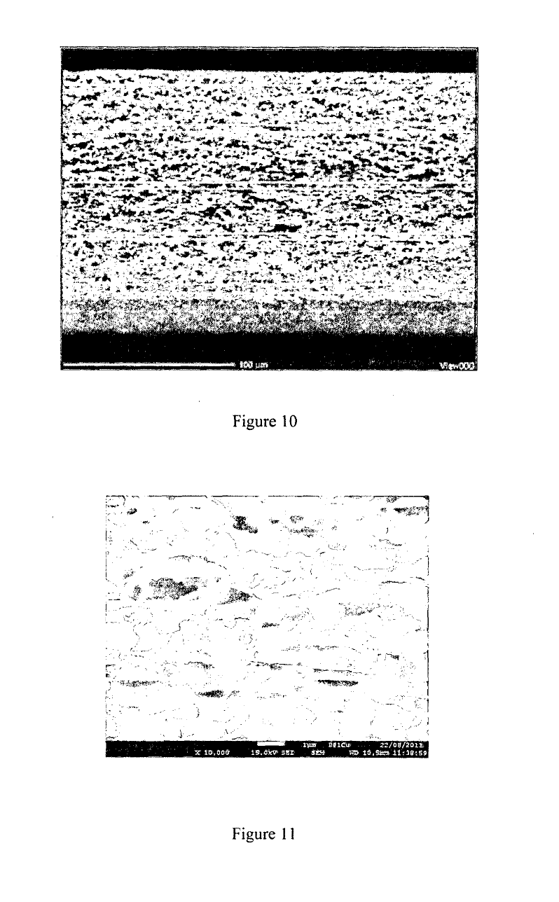

A solution composition was prepared for coating nickel containing compound (0.1M NiSO₄ and 0.02M triethanolamine in deionized water pH was 8.5-9.0). The Al₂O₃ coated cellulose acetate membrane was prepared similarly to example 1 and was immersed into the solution for over 4 hours at room temperature, the nickel containing compound coated the membrane giving it a uniform green colour. After the coating process, the membranes were rinsed thoroughly with deionized water and dried in an oven at 60-70° C. Then the membranes coated with nickel containing compound were analysed with SEM and EDS (FIGS. 9 and 10). The results indicated that thin and uniform nickel containing coatings were formed all through the 3D porous structure of Al₂O₃ membranes. The EDS results are listed in Table 4.

TABLE 4

| at % | C | O | Al | S | Ni | Zn |
|---|---|---|---|---|---|---|
| A1 | 44.78 | 42.06 | 2.96 | 1.78 | 8.42 | — |
| A2 | 48.5 | 41.81 | 2.5 | 1.22 | 5.9 | 0.05 |
| A3 | 50.48 | 41.49 | 2.06 | 0.98 | 4.76 | 0.23 |
| A4 | 49.72 | 41.36 | 2.5 | 1.02 | 5.41 | — |
| A5 | 48.64 | 41.22 | 2.51 | 1.13 | 6.5 | — |

### Example 9

### Nickel Containing Compound Coating on ZnO Coated Cellulose Acetate Membranes

The same procedures of example 8 were followed except the cellulose acetate membranes were coated with ZnO. The membrane sample developed a uniform green colour indicating formation of a nickel-containing compound.

### Comparative Example 2

### Nickel Containing Compound Coating on Cellulose Acetate Membranes without Metal Oxide Coating

The same procedures of example 8 were followed except that a cellulose acetate membrane without any coating was used. After 4 hours of immersion in the deposition solution the membrane had not changed colour and there was no weight gain, indicating that no coating had occurred.

### Example 10

### Palladium Containing Compound Coating on Al₂O₃ Coated Cellulose Acetate Membranes

The solution composition for coating palladium containing compound was 1 mM PdCl₂ in deionized water, and the solution pH was 5.0 (adjusted with. NaOH solution). The Al₂O₃ coated cellulose acetate membrane was prepared similarly to example 1 and was immersed into the solution for 10-15 minutes at room temperature. After the coating process, the membranes were rinsed thoroughly with deionized water and dried in oven at 60-70° C. It was visually observed that the membranes turned a uniform brown colour after coating with palladium containing compound.

### Example 11

### Palladium Containing Compound Coating on ZnO Coated Cellulose Acetate Membranes

The same procedures of example 10 were followed except the cellulose acetate membranes were coated with ZnO. The membrane turned a uniform brown colour after coating.

### Example 12

### Silver Containing Compound Coating on Al₂O₃ Coated Cellulose Acetate Membranes

The solution composition for coating silver containing compound was 0.1 M AgNO₃ in deionized water, and the solution was brought to be just cloudy with NaOH solution. The Al₂O₃ coated cellulose acetate membrane was prepared similarly to example 1 and was immersed into the solution for 4 hours at room temperature. After the coating process, the membranes were rinsed thoroughly with deionized water and dried in oven at 60-70° C. It was visually observed that the colour of the membranes turned into brown after coated with silver containing compound.

### Example 13

### Sodium Borohydride Reduction of Copper Containing Compound Coating

A copper containing compound coated membrane was prepared similarly to example 5. The membrane was the immersed into a 1M solution of sodium borohydride for 30 mins. Significant bubble generation was observed to occur from the membrane and during immersion the membrane turned a uniform deep black copper colour.

### Example 14

### Sodium Borohydride Reduction of Nickel Containing Compound Coating

A nickel containing compound coated membrane was prepared similarly to example 8. The membrane was the immersed into a 1M solution of sodium borohydride for 30 mins. Significant bubble generation was observed to occur from the membrane and during immersion the membrane turned a uniform deep black colour.

### Example 15

### Dimethyl Amine Borane Reduction of Copper Containing Compound Coating

A copper containing compound coated membrane was prepared similarly to example 5. The membrane was the immersed into a 1 g/L solution of Dimethyl amine borane(pH=10) for 30 mins. Significant bubble generation was observed to occur from the membrane and during immersion the membrane turned a uniform deep black copper colour.

### Example 16

### Electroless Copper Coating onto Palladium Containing Compound Coated Membrane

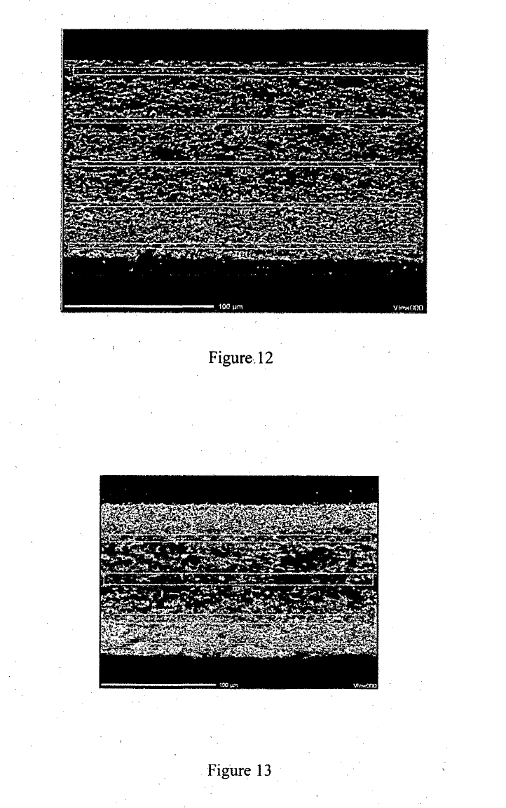

A palladium containing compound coated cellulose acetate membrane was prepared similarly to example 10. The membrane was rinsed in water after palladium containing compound coating and then transferred to a copper electroless solution containing: 1.8 g/L Copper Sulphate, 25 g/L Rochelle salt, 5 g/L Sodium hydroxide, 10 g/L 37% Formaldehyde. A uniform coating onto the cellulose acetate membrane was achieved by flowing the solution through the membrane during deposition. A bright electroless copper coating was formed after 10 mins of deposition. Electron micrograph images of the cross-section of the copper coated membrane are shown in FIG. 11. The location of EDS area scans and the EDS results are shown in FIG. 12. The EDS results are listed in Table 5.

TABLE 5

| | C | O | Al | Cu | Zn | |
|---|---|---|---|---|---|---|
| Element | (at %) | (at %) | (at %) | (at %) | (at %) | Cu/Zn |
| Line 1 | 9.2 | 13.6 | 1.6 | 44.3 | 31.0 | 1.4 |
| Line 2 | 12.5 | 15.6 | 0.8 | 39.3 | 31.5 | 1.2 |
| Line 3 | 17.1 | 17.6 | 0.4 | 30.1 | 34.7 | 0.9 |
| Line 4 | 14.1 | 14.3 | 0.4 | 32.2 | 38.7 | 0.8 |
| Line 5 | 11.4 | 8.3 | 0.3 | 37.2 | 42.9 | 0.9 |

### Example 17

### Electroless Copper Coating onto Palladium Containing Compound Coated Glass Slide

Similar procedures to example 16 were followed except the substrate was a glass slide. The electroless deposition was performed in a glass beaker without flowing the solution. A bright electroless copper coating was observed after 10 minutes of deposition.

### Comparative Example 3

### Electroless Copper Coating onto Al₂O₃ Coated Cellulose Acetate Membrane

Similar procedures to example 16 were followed except no palladium containing compound coating had been applied to the alumina coated membrane substrate. Visually no copper deposition was observed to occur.

### Example 18

### Electroless Nickel Coating onto Palladium Containing Compound Coated Membrane

Similar procedures to example 16 were followed except the sample was transferred to a commercial nickel electroless solution. A bright nickel deposit formed on the membrane sample after 10 mins of deposition.

### Example 19

### Electroless Nickel Coating onto Palladium Containing Compound Coated Glass Slide

Similar procedures to example 16 were followed except the substrate was a glass slide and the sample was transferred to a commercial nickel electroless solution. A bright nickel deposit formed on the glass sample after 10 mins.

### Comparative Example 4

### Electroless Nickel Coating onto Al₂O₃ Coated Cellulose Acetate Membrane

Similar procedures to example 18 were followed except no palladium containing compound coating had been applied to the alumina coated membrane substrate. Visually no nickel deposition was observed to occur.

### Example 20

### Electroless Copper Coating onto Copper Containing Compound Coated Membranes

A copper-containing compound coated cellulose acetate membranes with a pore size 0.2 micron was prepared similarly to example 5. The sample was then reduced in a solution of 1 g/L dimethyl amine borane (DMAB), pH adjusted to 10 with potassium hydroxide, for 2 hours. The reduction treatment causes the copper containing compound coating to turn a deep black copper colour. The sample was immediately transferred to a DMAB electroless copper solution, the deposition occurred over 18 hrs with constant stirring. The composition of the DMAB electroless solution was: 0.5 g/L DMAB, 0.5 g/L Copper Sulphate, 2.5 g/L EDTA, 6 ml/L Tri-ethanol amine, pH adjusted to 9.5 with potassium hydroxide. The deposition produced a copper coated membrane. SEM/EDS results (FIG. 13) showed that the copper deposition had penetrated approximately 30 microns into the membrane from both sides. The EDS results are listed in table 6.

TABLE 6

Element

| | C | O | Cu | Cu/C |
|---|---|---|---|---|
| Line 1 | 32.3 | 6.35 | 61.34 | 1.89 |
| Line 2 | 54.2 | 20.81 | 25 | 0.46 |
| Line 3 | 60.67 | 30.94 | 8.34 | 0.13 |
| Line 4 | 60.17 | 26.33 | 13.46 | 0.22 |
| Line 5 | 44.8 | 12.21 | 42.95 | 0.95 |

### Example 21

### Electroless Copper Coating onto Copper Containing Compound Coated Membranes

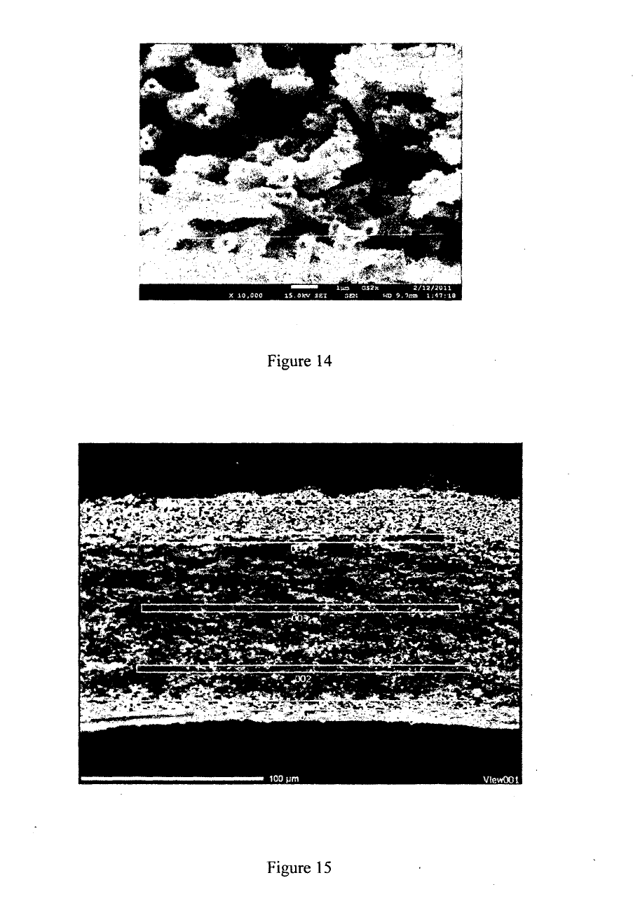

A copper containing compound coated cellulose acetate membranes with a pore size 0.2 micron was prepared similarly to example 5. The sample was reduced in a solution of 1 g/L dimethyl amine borane (DMAB), pH adjusted to 10 with potassium hydroxide, for 2 hours. The sample was then loaded in a flow cell and fresh reduction solution was flowed through the membrane for 30 mins. The reduction treatment causes the copper containing compound coating to turn a deep black copper colour. Immediately following a DMAB electroless copper solution was flowed through the membrane for 18 hours, the composition of the solution was: 0.5 g/L DMAB, 0.5 g/L Copper Sulphate, 2.5 g/L EDTA, 6 ml/L Tri-ethanol amine, pH adjusted to 9.5 with potassium hydroxide. The deposition produced a copper coated membrane. High resolution SEM (FIG. 14) shows that locally the coating is thin, uniform and continuous throughout the membrane. SEM/EDS analysis (FIG. 15) indicates that on a larger length scale the coating did not penetrate evenly throughout the entire thickness of the membrane. The EDS results are listed in table 7.

TABLE 7

| | Element | | | | |
|---|---|---|---|---|---|
| | C | O | Al | Cu | |
| | (at %) | (at %) | (at %) | (at %) | Cu/C |
| A1 | 44.81 | 18.37 | 0.33 | 36.48 | 0.81 |
| A2 | 55.23 | 21.78 | 0.25 | 22.74 | 0.41 |
| A3 | 56.96 | 26.21 | 0.71 | 16.12 | 0.62 |
| A4 | 39.35 | 16.16 | 0.6 | 43.89 | 1.12 |
| A5 | 39.25 | 8.4 | 0.04 | 52.31 | 1.33 |

### Comparative Example 5

### Electroless Copper Coating onto Copper Containing Compound Coated Membranes without Reduction Step

Similar procedures to example 21 were followed except the sample was not subjected to reduction treatment prior to being transferred to the electroless copper solution. Visually no copper deposition was observed to occur.

### Example 22

### Electroless Nickel Coating onto Copper Containing Compound Coated Membranes

A copper containing compound coated cellulose acetate membranes with a pore size 0.2 micron was prepared similarly to example 5. The sample was reduced in a solution of 1 g/L dimethyl amine borane (DMAB), pH adjusted to 10 with potassium hydroxide, for 30 mins at 50 deg C. The sample was then immediately transferred to a nickel electroless solution, the deposition occurred over 1 hour with constant stirring. The composition of the nickel electroless solution was: 0.05 M DMAB, 0.1 M Nickel Sulphate, 0.2M Citric acid, pH adjusted to 9 with potassium hydroxide. Visually we observed a nickel coating.

### Comparative Example 6

### Electroless Nickel Coating onto Copper Containing Compound Coated Membranes without Reduction Step

Similar procedures to example 22 were followed except the sample was not subjected to reduction treatment prior to being transferred to the electroless nickel solution. Visually no nickel deposition was observed to occur.

### Example 23

### Electroless Copper Coating onto Silver-Containing Compound Coated Membrane

A silver-containing compound coated cellulose acetate membrane with a pore size of 0.2 micron was prepared similarly to example 12. The sample was then placed in a copper DMAB electroless solution consisting of: 2 g/L DMAB, 2 g/L Copper Sulphate, 10 g/L EDTA, 25 ml/L Tri-ethanol amine, pH adjusted to 9.5 with potassium hydroxide. Visually we observed a copper coating.

### Example 24

### Electroless Nickel Coating onto a Fibrous Membrane Coated with a Copper-Containing Compound

A fibrous membrane material, approximately 40 micrometres thick with porosity ˜57%, was first coated with alumina using 13 cycles of trimethylaluminium with water as oxidant. The surface area of the uncoated membrane material was 1 m²/cc. This was then coated with a copper-containing compound in a similar manner to example 5. The copper containing compound was reduced using a sodium borohydride solution, flowed through the membrane for 15 minutes. Then a nickel electroless solution was flowed through the membrane for times of 15 minutes, 30 minutes and 60 minutes. Visually the nickel coating extended through the membranes. The estimated average coating thicknesses, volume fractions of solid, conductivities and equivalent conductivities are shown in table 8.

TABLE 8

| | Estimated | | | |
|---|---|---|---|---|
| | average | | | |
| | coating | | | |
| Ni Coating | thickness | Volume | Conductivity | Equivalent |
| Time (mins) | (nm) | fraction solid | Ωm | Conductivity Ωm |
| 15 | 112 | 11% | 2.13E+04 | 1.86E+05 |
| 30 | 181 | 18% | 4.35E+04 | 2.35E+05 |
| 60 | 208 | 21% | 6.25E+04 | 2.94E+05 |

### Examples 25-42

Various porous substrates were coated with electroless nickel for various times using similar methods to previous examples. The coatings generally were present all through the membranes. The amounts of nickel were determined and resistivities measured using a four-point setup. For example 38, the substrate was coated with copper then nickel. For examples 41 and 42, two 127 μm membranes were pushed together and processed as one membrane, as an example showing applicability to membranes of greater thickness. Table 9 shows the results, including average thicknesses, and equivalent conductivities.

TABLE 9

| | | | | | | Estimated |
|---|---|---|---|---|---|---|
| | | | | | | average |
| | | Ni | | | Equivalent | nickel |
| Example | | deposition | Vf | Resistivity | conductivity | thickness |
| number | Substrate Type | time (mins) | nickel | ohm*m | S/m | (nm) |
| 25 | Cellulose acetate | 6 | 11% | 6.30E−05 | 1.48E+05 | 10.7 |
| | nominal pore size | | | | | |
| | 0.2 μm 66% porosity, | | | | | |
| | 127 μm thick | | | | | |
| 26 | As for 25 | 30 | 14% | 1.40E−05 | 4.93E+05 | 14.5 |
| 27 | Cellulose acetate nominal | 6 | 12% | 9.30E−05 | 8.88E+04 | 25.8 |
| | pore size 0.45 μm 66% | | | | | |
| | porosity, 127 μm thick | | | | | |
| 29 | As for 27 | 15 | 21% | 4.30E−05 | 1.10E+05 | 45.1 |
| 30 | As for 27 | 30 | 23% | 9.00E−06 | 4.93E+05 | 48.0 |
| 31 | Cellulose acetate nominal | 6 | 2% | 2.20E−03 | 1.98E+04 | 10.0 |
| | pore size 0.8 μm 66% | | | | | |
| | porosity, 127 μm thick | | | | | |
| 32 | Polyethersulfone nominal | 6 | 8% | 7.68E−04 | 1.56E+04 | 26.9 |
| | pore size 0.45 μm 73% | | | | | |
| | porosity, 100 μm thick | | | | | |
| 33 | As for 32 | 15 | 32% | 1.48E−05 | 2.15E+05 | 101.9 |
| 34 | As for 32 | 30 | 33% | 1.10E−05 | 2.78E+05 | 105.6 |
| 35 | Fibrous membrane, 57% | 15 | 9% | 4.70E−05 | 2.41E+05 | 88.2 |
| | porosity, 40 μm thick. | | | | | |
| 36 | As for 35 | 30 | 11% | 2.30E−05 | 4.04E+05 | 107.6 |
| 37 | As for 35 | 60 | 11% | 1.60E−05 | 5.53E+05 | 112.9 |
| 38 | Cellulose acetate nominal | 6 ni 3 cu | 9% | 2.79E−05 | 3.87E+05 | 19.7 |
| | pore size 0.45 μm 66% | | | | | |
| | porosity, 127 μm thick | | | | | |
| 39 | Cellulose acetate nominal | 15 | 5% | 1.25E−04 | 1.68E+05 | 39.8 |
| | pore size 5 μm 66% | | | | | |
| | porosity, 127 μm thick | | | | | |
| 40 | As for 39 | 30 | 4% | 7.68E−05 | 3.13E+05 | 34.6 |
| 41 | Cellulose acetate nominal | 15 | 14% | 1.52E−05 | 4.59E+05 | 30.5 |
| | pore size 0.45 μm 66% | | | | | |
| | porosity, 254 μm thick | | | | | |
| | (2 × 127 μm thick) | | | | | |
| 42 | as for 41 | 30 | 20% | 8.60E−06 | 5.86E+05 | 42.2 |
| 43 | Fibrous membrane, ~85% | 15 | 5% | 8.90E−05 | 2.19E+05 | 18.7 |
| | porosity, 85 μm thick. | | | | | |

### Example 44

### Electroless Nickel Coatings onto Cellulose Acetate Filter Membranes

Nickel coatings were deposited onto cellulose acetate filter membranes using similar methods to previous examples. The surface areas measured over three samples were 37.7 m²/g, 31.2 m²/g and 61.6 m²/g.

Those skilled in the art will appreciate that the present invention may be susceptible to variations and modifications other than those specifically described. It will be understood that the present invention encompasses all such variations and modifications that fall within its spirit and scope.

Throughout this specification, the term “comprising” and its grammatical equivalents shall be taken to have an inclusive meaning unless the context of use indicates otherwise.

The applicant does not concede that prior art discussed in this specification forms part of the common general knowledge in Australia or elsewhere.

1-89. (canceled)

90. A method for depositing a metal containing material onto a porous substrate, the method comprising:
(a) forming a seed coating on the substrate, wherein the seed coating at least partially covers the substrate, the seed coating being substantially free of precious metal; and;
(b) applying a metal containing material to the seed coating, wherein the surface area of the substrate is greater than 0.02 m²/cm³, as determined prior to coating the substrate and the metal containing material applied in step (b) forms a layer having a thickness of less than 500 nm.

91. A method as claimed in claim 90 wherein the porous substrate is first coated with a surface modification material comprising a metal and oxygen, wherein the surface modification material at least partially coats the porous substrate wherein the coating of surface modification material is preferably less than 5 nm thick, more preferably less than 2 nm thick, even more preferably less than 1 nm thick and wherein the surface modification material is applied using atomic layer deposition.

92. A method as claimed in claim 90 or 91 wherein the method for forming the seed coating further comprises the steps of:
(i) applying an initial chemically reducible metal containing material to the substrate, and
(ii) subsequently chemically reducing at least part of the chemically reducible metal containing material to form a seed coating; and
wherein preferably the step of chemically reducing the initial chemically reducible metal containing material reduces at least some of the chemically reducible metal containing material to a metal.

93. A method as claimed in any one of the preceding claims wherein the initial chemically reducible metal containing material comprises a hydroxide, an oxyhydroxide or a carbonate, or mixtures of two or more thereof and wherein the initial chemically reducible metal containing material preferably comprises a nickel containing material, or a copper containing material, or a nickel containing material and a copper containing material or more preferably nickel and/or copper.

94. A method as claimed in any one of the preceding claims wherein at least part of the porosity in the substrate is interconnected and open to the surface and wherein the substrate preferably has a volume fraction of pores of at least 30% and more preferably at least 50%, as determined prior to coating the substrate.

95. A method as claimed in any one of the preceding claims wherein the substrate has a thickness of at least 1 μm and preferably at least 100 μm and more preferably in the range of from 100 μm to 500 μm.

96. A method as claimed in any one of the preceding claims wherein deposition of any of the coatings is carried out from a liquid that flows into at least some of the pores in the membrane and preferably the metal-containing material is applied to the substrate from the fluid that is flowed through the pores of the membrane.

97. A coated material comprising:
a porous substrate, and
a coating that at least partially coats the porous substrate, the coating comprising
a seed coating, wherein the seed coating is substantially free of precious metal, and
a metal containing material on the seed coating, wherein the surface area of the porous substrate is at least 0.02 m²/cm³ and wherein the metal containing material forms a layer having a thickness of less than 500 nm.

98. A coated material in accordance with claim 97 wherein the seed coating comprises an initial metal containing material formed by reducing an initial chemically reducible material and wherein the seed layer preferably comprises a nickel containing material, or a copper containing material, or a nickel containing material, or a copper containing material, or nickel, or copper, or nickel and copper.

99. A coated material as claimed in any one of claim 98 wherein the substrate has a thickness of at least 1 μm and wherein the seed coating has a thickness of less than 20 nm, preferably less than 10 nm and more preferably less than 5 nm.

100. A coated material as claimed in any one of claims 97 to 99 wherein at least some of the pores in the substrate are interconnected and wherein the metal containing material comprises a layer of metal containing material on the seed layer.

101. A coated material as claimed in any one of claims 97 to 100 further comprising a surface modification coating of a metal and oxygen applied to the substrate, the seed layer being applied to the layer of the metal and oxygen and wherein a thickness of the surface modification coating is preferably less than 5 nm, more preferably less than 2 nm, even more preferably less than 1 nm.

102. A coated material as claimed in any one of claims 97 to 101 wherein the metal containing material increases electrical conductivity of the material such that the equivalent conductivity of the material after the metal containing material is applied is preferably greater than greater than 1×10³ S/m, or greater than 1×10⁴ S/m, or greater than 1×10⁵ S/m, or greater than 1×10⁶ S/m or between 1×10³ S/m to 1×10⁷ S/m or between 1×10³ S/m to 1×10⁶ S/m and wherein the average thickness of the second metal containing layer is preferably less than 500 nm.

103. A coated material as claimed in any one of claim 98 or claims 99 to 102 when dependent on claim 9 wherein the initial metal containing material of the seed layer comprises a metal hydroxide or a metal oxyhydroxide.

104. A coated material as claimed in any one of claims 97 to 103 wherein the metal containing material has a volume fraction of from 2 to 33%, preferably from 4 to 32%, more preferably from 5 to 20%, more preferably from 5 to 18%.
